(19) United States
(12) Patent Application Publication
(10) Pub. No.: US 2003/0182761 A1
(43) Pub. Date: Oct. 2, 2003

(54) Hinge pin and replacement method for vehicle door hinge

(76) Inventor: Gaylon M. Kidd, Rupert, ID (US)

Correspondence Address: ROBERT FROHWERK, 551 CLEARVUE DRIVE, MERIDIAN, ID, 83642, US

(21) Appl. No.: 10/427,195

(22) Filed: Apr. 29, 2003

Related U.S. Application Data
(60) Provisional application No. 60/393,779, filed on Jul. 2, 2002.

(51) Int. Cl. E05D 5/10

(52) U.S. Cl. 16/386; 16/340

(57) ABSTRACT

Replacement hinge pin and a method of installation allow door hinges of a motor vehicle to be repaired at low cost. Repeated opening and closing of the door results in wear of one or more of the factory-installed hinge pins and the bushings or apertures that support them. This wear causes the door to sag out of alignment with its striker and latching plates causing additional damage if not repaired. The repair assembly includes at least one hinge pin and associated hardware to position and retain it. The method of replacement is extremely efficient and cost effective when compared to the standard practice recommended by vehicle manufacturers.

### CROSS-REFERENCES TO RELATED APPLICATIONS

This application claims the benefit of U.S. Provisional Patent Application No. 60/393,779, filed Jul. 2, 2002, entitled “Replacement Hinge Pin Assembly For Vehicle Door Hinge” which is incorporated here in its entirety by reference.

### STATEMENT REGARDING FEDERALLY SPONSORED RESEARCH OR DEVELOPMENT

Not Applicable

### SEQUENCE LISTING OR PROGRAM

Not Applicable

### DESCRIPTION

1. FIELD OF THE INVENTION

The present invention relates to hinges in general, and specifically to an aftermarket replacement hinge pin assembly for use on a motor vehicle door, as well as a method for installing the hinge pin assembly as a replacement.

### BACKGROUND

It is common for many types of vehicle door hinges to suffer from premature breakdown of the hinge assembly. This is understandable by a simple analysis of the manner in which typical vehicle doors are supported. Most vehicle doors swing about a generally vertical axis that is defined by the relative positions of upper and lower hinge assemblies. The design of most vehicles is such that the vertical spacing between the hinges is less than the horizontal width of the door opening. When the door is in any position other than fully closed, the hinges alone must support its full weight, which is exacerbated by the leverage effect of the width relative to the spacing between the hinges. Only when the door is in its closed position do the striker and latching mechanisms provide support to offload the moment applied to the hinges. Repeated opening and closing of the door tends to wear the surfaces at the pivot points within the hinges. This wear allows the door to sag which leads to misalignment within its opening in the vehicle until it becomes difficult to open and close the door properly. If this misalignment is not corrected in a timely manner, subsequent damage to the door latch and striker is likely to occur which often requires that they be replaced as well.

To accommodate production on high-speed assembly lines, it has become common to use a two-part hinge with removable hinge pins to support the doors. One version of this process is described by Worden, et al. in their U.S Pat. No. 5,950,295 and its division, U.S. Pat. No. 6,178,599. To facilitate this and similar processes, one part of the hinge is welded to the body of the vehicle and the other part to the door. The door is mounted to the body by using temporary hinge pins to couple the body and door halves of the hinges. The body is then painted and cured with the doors in place to achieve the best possible match of color and finish, after which the temporary hinge pins are removed. This allows the doors to be finished separately with interior trim, window glass and hardware on one branch of an assembly line while the body is treated on another branch. When the doors are later reunited with the matching body, permanent hinge pins are inserted to hold the hinge halves together. After insertion, the hinge pins are welded, riveted, or peened or otherwise flared to prevent them from being dislodged or removed. Because this approach to hinge assembly offers no provision for adjusting alignment, a worn hinge is typically replaced in its entirety, at considerable expense to the owner of the vehicle due primarily to the time-consuming labor involved.

The illustrated embodiment of this invention relates specifically to the vertical split pin hinge assembly that is commonly found on vehicles designed by General Motors, in particular, on Chevrolet pickup trucks. A split pin style of hinge can be understood as if a single longer hinge pin were to be separated into multiple, generally two, pieces by removal of a portion of the length of the pin where that portion is not necessary to provide a bearing surface, for mounting, for handling or another purpose, the residual portions of the split pin remaining in axial alignment with one another. When any part of this style of hinge bracket assembly wears out or is damaged, the only recourse presently available is to completely remove the original hinge body bracket and replace it with a new bracket of the same design. This is a time consuming and expensive process whereby the welded hinge bracket must be laboriously removed and the new bracket must be precisely realigned prior to being reattached to the vehicle pillar by yet another extremely tedious process. The new bracket must then be repainted to match the vehicle body.

While numerous attempts have been shown to improve the vehicle door hinge in order to facilitate production on an assembly line, little has been disclosed in the prior art that would benefit the aftermarket body shop business, or anyone needing to repair a damaged door hinge. U.S. Pat. No. 6,178,593 issued to Carlson provides an apparatus to compensate for hinge wear, however, it applies to a different style hinge and attempts to compensate for wear to the hinge bracket itself. In U.S. Pat. No. 4,654,929 Fahnders addresses the problem of worn and sagging hinges on still another type of hinge assembly.

Nowhere within the prior art is there a method supplied for simply replacing the worn bushing or hinge pin assembly on either a single or dual (split) pin type hinge, particularly those that are welded into place. For overworked mechanics and their time- and cost-conscious customers, a quick and affordable solution for this annoying problem is needed.

### BRIEF SUMMARY OF THE INVENTION

It is the primary objective of this invention to provide a replacement hinge pin assembly and a method of replacing said hinge pin assembly for a vertical split pin vehicle door hinge of the type now commonly used on vehicles manufactured by General Motors.

The present invention also provides a method for replacing worn hinge pins and bushings that is both time and cost effective. With this method, the owner of the vehicle will experience approximately one-third of the current cost of a complete hinge bracket replacement.

It is a further objective of the invention to provide a replacement hinge pin assembly that can be used on other styles of hinge brackets for quick replacement when either the bushings or the pin itself has become worn.

An additional advantage of this invention is that once a door has had the described hinge pins installed, that door may be easily removed at any time to facilitate additional repairs or service as needed.

### BRIEF DESCRIPTION OF THE DRAWINGS

FIG. 1 shows an exploded side view identifying the features of a single instance of a hinge pin in a preferred embodiment of the invention.

FIG. 2 illustrates the components of a hinge pin assembly of the invention.

FIG. 3 shows the vehicle hinge body bracket and U-shaped bridge with the invention installed.

FIG. 4 illustrates the body bracket in the prior art with welded hinge pins.

FIG. 5 shows the door bracket.

FIG. 6 shows the body bracket with U-shaped link.

FIG. 7 illustrates the complete hinge assembly of the present invention mounted to the door bracket.

### DETAILED DESCRIPTION

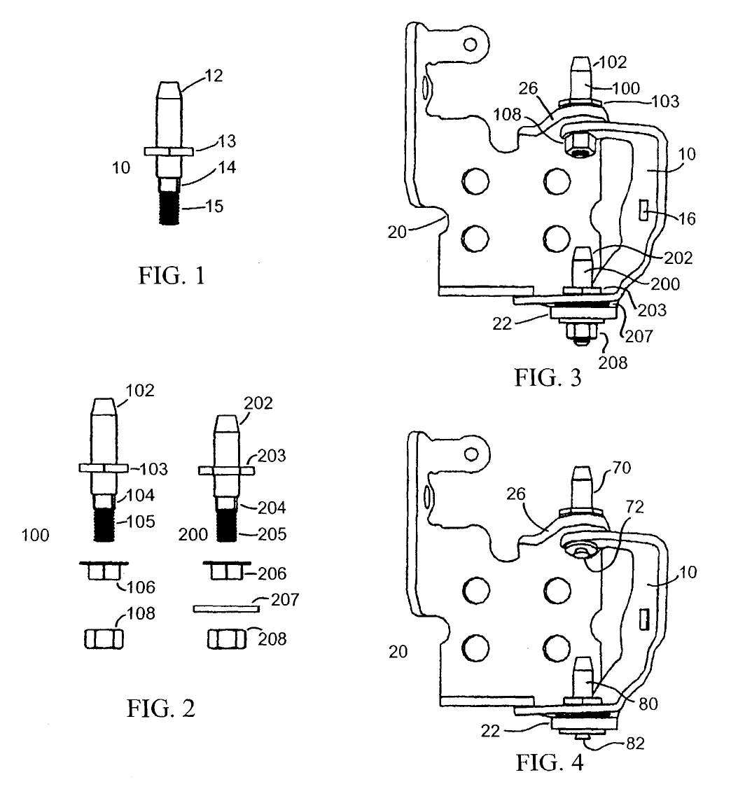

Refer to FIG. 1 which points out the features of a hinge pin 10 in a preferred embodiment of the present invention. The hinge pin 10 is shown in the same orientation in which it will normally be used. The basic form of the body of the hinge pin is cylindrical; it has two readily distinguishable ends with a radially extending flange between those ends. Hinge pin 10 has a tapered end 12 that facilitates engagement with apertures for mounting. The amount of taper is generally non-critical to most applications so that the ratio of the diameter at the end of the hinge pin to the nominal body diameter may range from about 40% to about 90% and the length of the tapered region may range from about 40% of the nominal body diameter to somewhat more than that diameter. In some applications, instead of a linear taper, it may be desirable to use an alternate profile, one possibility being a quarter-round. The bluntness or sharpness of the tapered end 12 will depend on the relative diameters of the mounting apertures that it will engage and the thickness of associated hinge members.

Extending radially from the body of the hinge pin 10 is a tool-receiving flange 13. The flange 13 is located generally midway along the length of the hinge pin 10; the absolute location of the flange 13 along that length being dependent upon the dimensions of the particular model of hinge that is to be repaired. The tool-receiving flange 13 of one preferred embodiment will have a hexagonal cross-section relative to the longitudinal axis of the hinge pin 10; this will properly engage many forms of wrenches commonly used in the industry. In other embodiments, the tool-receiving flange 13 may have a non-hexagonal polyhedral cross-section to accommodate engagement by less commonly used wrenches, or it may be circular for reception by other tools such as gripping devices, the most common being pliers. The diameters (inner and outer, when different) of the tool-receiving surface of the flange 13 will be in keeping with standard engineering practice for the loads and torques expected to be encountered by the hinge pin 10, but at minimum will be large enough to provide a shoulder that comfortably covers variations in manufacturing tolerances of the mounting apertures of the hinge brackets with which it will be associated. The thickness of the flange 13 will similarly be determined by load requirements in addition to the need to provide sufficient surface area for proper contact with the tools that it is designed to engage.

The end of hinge pin 10 opposite the tapered end 12 is a threaded end 15.

The threaded region has a length suitable to allow secure attachment using standard hardware as with a variety of lock nuts or combinations of lockwashers and nuts. A portion of the region of the hinge pin 10 between the flange 13 and the threaded end 15 may have a knurled surface 14 to provide a secure seat for a bushing when the hinge pin 10 is tightened into mounting apertures of the hinge brackets. Any such knurled surface will be of such length as to accommodate a bushing appropriate to the thickness of the hinge bracket that will pivot about it.

FIG. 2 takes two instances of the generalized hinge pin shown in FIG. 1 but varying slightly one from the other, and adds hardware commonly available in the industry to complete a kit for the repair of one (dual) split pin hinge; two such kits being required for replacement of both hinges on one vehicle door.

One kit consists of hinge pins 100 and 200, replacement bushings 106 and 206, and lock nuts 108 and 208. The pin assembly 200 additionally includes a commonly available washer 207.

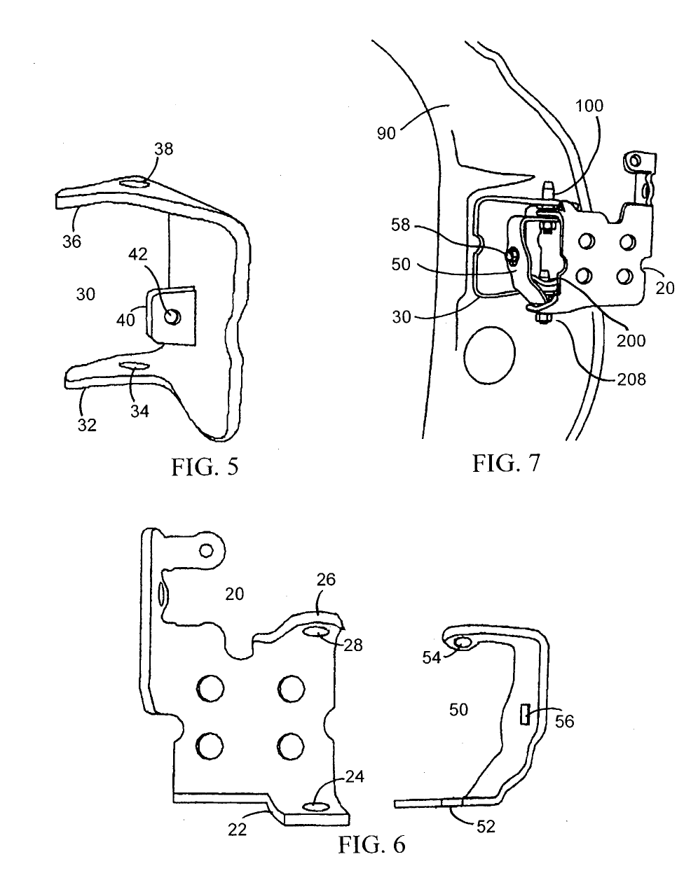

The hinge pins 100 and 200 have tapered ends 102 and 202, which allow for the door bracket mounting apertures 34 and 38 (FIG. 5) to easily slide onto them. The length of the upper portion of the upper hinge pin 100, that is, the length from the tool-receiving flange 103 to the extreme of the tapered end 102, is typically greater than the corresponding length of hinge pin 200 to facilitate alignment of hinge and door subassemblies during installation. Opposite the tapered ends 102 and 202 of hinge pins 100 and 200 are threaded ends 105 and 205, which are of a length suitable to allow secure attachment of lock nuts 108 and 208. Tool-receiving flanges 103 and 203, extend radially from the surfaces of hinge pins 100 and 200, orthogonal to their longitudinal axes, between the tapered ends 102 and 202 and threaded ends 105 and 205. Said tool-receiving flanges 103 and 203 of a preferred embodiment will have a hexagonal shape to provide contact surfaces for a wrench of either English or metric sizing to be used when tightening the lock nuts 108 and 208.

The region of the hinge pins 100 and 200 between the flanges 103 and 203 and the threaded portions 105 and 205 may have a knurled surface 104 and 204 to provide a secure seat for the bushings 106 and 206 when the assembly is tightened into the body bracket apertures 28 and 24, shown in FIG. 6 but not visible in FIG. 3. This is necessary to keep the bushings 106 and 206 tightly seated. Bushings 106 and 206 may be of any suitable bushing material, including but not limited to alloys of copper, such as brass and bronze, which are commonly used for the construction of bushings. In a preferred embodiment they will be of the same self-lubricating material as used by the original equipment manufacturer.

In a particular embodiment of the invention the lower hinge pin assembly 200 requires the addition of a commonly available washer 207 to be inserted between the U-shaped link 50 and the lower body bracket arm 22.

FIGS. 4, 5 and 7 illustrate the commonly used split pin style of vehicle door hinge where the body bracket 20 is to be attached to the vehicle pillar. In a factory-installed hinge using the prior art, a U-shaped link 50 is rotatably attached to the body bracket 20 by means of an upper hinge pin assembly 70 and a lower hinge pin assembly 80 where their ends 72 and 82, respectively, have been welded into place. The door bracket 30 of FIG. 5 is welded to the vehicle door 90 and then pivotally mounted onto the hinge pins 70 and 80 by means of mounting holes 34 and 38, respectively, in the door bracket legs 32 and 36. The U-shaped link 50 is then attached to the door bracket 30 by means of a bolt 58 (in FIG. 7) through an aperture 56 in the U-shaped link 50 and an aperture 42 in a tab 40 on the door bracket 30.

The process of replacing the original welded hinge pins 70 and 80 begins with their removal from the hinge. This may be accomplished by various means.

The most common method of removal involves grinding off the lower end 72 and 82 of each pin 70 and 80. A similar grinding operation applies whether the existing pins were originally welded, riveted, or peened or otherwise flared, to hold them in place. Once released, these pins may be removed and discarded.

Next, the U-shaped link 50 is removed and set aside; the worn bushings (not visible in FIG. 4) are also removed and discarded.

The replacement bushings 106 and 206 are then inserted and tapped securely into place in the body bracket apertures 28 and 24 from whence the worn bushings were removed. The threaded end 105, of upper replacement hinge pin 100 is inserted into bushing 106, the upper aperture 54 of U-shaped link 50 slides onto the threaded end 105 of upper pin 100 and the lower aperture 52 of U-shaped link 50 is positioned above lower bushing 206. Threaded end 205 of lower hinge pin 200 is then dropped into position through the lower aperture 52 of U-shaped link 50, through washer 207, and through lower bushing 206.

Once U-shaped link 50 is in place, the two lock nuts 108 and 208 are attached to the threaded ends 105 and 205 of hinge pins 100 and 200 and tightened by using the tool-receiving flanges 103 and 203 to provide opposing force.

After hinge pins 100 and 200 have been properly tightened, door bracket 30 is slipped over tapered ends 102 and 202 of the respective hinge pins 100 and 200 and is then reattached to the body bracket 20 by means of a bolt 58 through aperture 56 in U-shaped link 50 and an aperture 42 in a tab 40 on door bracket 30. In a preferred embodiment of the hinge pin assembly, the upper portion of hinge pin 100 above the flange 103 will be longer than the corresponding length of hinge pin 200 so that door bracket 30 will be slipped over tapered end 102 first and then over tapered end 202; this provides for an easier alignment of the hinge members than would be the case if hinge pins 100 and 200 had the same lengths protruding above the brackets.

The exact size and dimension of the actual hinge pin may vary according to the particular hinge style but the discerning feature will be the radially extending flange for receiving a tightening tool. This flange also provides support for the pin so that if the replacement bushing should become worn, the pin will be prevented from moving within the bracket apertures.

The hinge pin 100 and 200 with radially extending flange may be produced by various methods. The preferred method is to machine each hinge pin from a single piece of solid stock so that the flange is an integral part of the pin for added strength and durability. Other methods of production are well understood in the industry and may include molded or welded parts.

While the present invention has been described as an aftermarket replacement for factory-installed hinge pins, there is no reason that the present invention could not be utilized as original equipment, especially for custom or short production runs. Furthermore, although described for use with motor vehicle doors, the present invention may also be of use in other hinge applications, such as gates. The hinge pins of the present invention will be especially useful where the tool-engageable flange facilitates ease of installation or adjustment.

Though the present invention has been described with reference to a preferred embodiment, various modifications will be apparent to those skilled in the art.

Therefore, it is not intended that the invention be limited to the disclosed embodiment or its details, and variations can be made within the spirit and scope of the appended claims.

I claim:

1. A hinge pin having first and second ends and a flange extending radially from the generally cylindrical body of said hinge pin between the first and second ends, wherein
(a) the first end is formed with a taper to facilitate entry of the hinge pin into an aperture;
(b) the second end is threaded to receive a threaded hardware fastener; and
(c) the flange is of sufficient diameter and thickness to:
(c1) support the load imposed by members of an associated hinge; and
(c2) provide contact surface area at the periphery of the flange for an installation tool to produce sufficient tightening force for the proper seating of said threaded hardware fastener.

2. The hinge pin of claim 1 wherein said flange is circular.

3. The hinge pin of claim 1 wherein said flange has a polyhedral tool-engageable section.

4. The hinge pin of claim 3 wherein the polyhedral tool-engageable section of said flange is hexagonal.

5. The hinge pin of claim 1 further comprising a knurled surface between the threaded region of the second end and the flange, said knurled surface to provide friction suitable to securely seat a bushing so as to restrict the rotation of said bushing relative to the hinge pin.

6. The hinge pin of claim 5 wherein said flange is circular.

7. The hinge pin of claim 5 whereinsaid flange has a polyhedral tool-engageable section.

8. The hinge pin of claim 7 wherein the polyhedral tool-engageable section of said flange is hexagonal.

9. A hinge pin assembly comprising a set of two hinge pins, each in full compliance with the characteristics of the hinge pin of claim 1, for replacement of a split pin style of hinge pin.

10. The hinge pin assembly of claim 9 further comprising standard threaded hardware fasteners applied to the second end of each hinge pin of said set of two hinge pins for the purpose of securing each hinge pin within mounting apertures of a hinge.

11. The hinge pin assembly of claim 10 wherein said standard threaded hardware fasteners are lock nuts.

12. The hinge pin assembly of claim 10 wherein said standard threaded hardware fasteners are nuts used in conjunction with lockwashers.

13. The hinge pin assembly of claim 9 for replacement of a split pin style of hinge pin wherein the flange of each hinge pin in said set of two hinge pins has a hexagonal tool-engageable section.

14. The hinge pin assembly of claim 13 wherein the length of the body between the taper of the first end of the first of said set of two hinge pins and the flange of the first of said set of two hinge pins is greater than the corresponding length of the second of said set of two hinge pins.

15. The hinge pin assembly of claim 13 further comprising standard threaded hardware fasteners applied to the second end of each hinge pin of said set of two hinge pins for the purpose of securing each hinge pin within mounting apertures of a hinge.

16. A hinge pin assembly comprising a set of two hinge pins, each in full compliance with the characteristics of the hinge pin of claim 8, for replacement of a split pin style of hinge pin, further comprising:
(a) bushings, which are common in the industry, seated onto the knurled surface of each hinge pin of said set of two hinge pins for the purpose of providing a rotatable pivot for each hinge pin within a mounting aperture of a hinge, and
(b) standard threaded hardware fasteners applied to the second end of each hinge pin of said set of two hinge pins for the purpose of securing each hinge pin within mounting apertures of a hinge.

17. The hinge pin assembly of claim 16 wherein said bushings are made of one of the many alloys containing copper that is commonly used for bushings.

18. The hinge pin assembly of claim 16 wherein said bushings are equivalent to those used by the original equipment manufacturer and are made of material that is self-lubricating.

19. A method of replacing hinge pins in a hinge assembly of the split pin style used on motor vehicle doors, comprising the steps of:
(a) releasing previously-installed pins and previously-installed bushings by removal of material that binds said previously-installed pins and said previously-installed bushings in hinge bracket apertures;
(b) removing from said hinge bracket apertures said previously-installed pins and said previously-installed bushings, and a U-shaped link, released by said releasing step;
(c) inserting replacement bushings, one into each of the upper and lower apertures of the hinge body bracket from whence said previously-installed bushings were removed by said removing step;
(d) installing two replacement hinge pins by the steps of:
(d1) inserting a threaded end of the first of said two replacement hinge pins into the replacement bushing captured in the upper aperture of the hinge body bracket from the upper side;
(d2) sliding the upper aperture of the U-shaped link onto said threaded end of the first of said two replacement hinge pins from the lower side;
(d3) positioning the lower aperture of the U-shaped link above the replacement bushing captured in the lower aperture of the hinge body bracket; and
(d4) slipping a threaded end of the second of said two replacement hinge pins through the lower aperture of the U-shaped link, then through a common washer, and then through the replacement bushing captured in the lower aperture of the hinge body bracket from the upper side; and
(e) securing each of said two replacement hinge pins against longitudinal displacement in said hinge bracket apertures, in a manner that allows pivotal movement, by applying a first and a second set of locking fastener hardware respectively to the threaded end of the first and the second of said two replacement hinge pins and tightening each of said first and said second set of locking fastener hardware by applying opposing force through a tool-receiving flange of the corresponding first and second of said two replacement hinge pins.

20. The method of claim 19 wherein one of said two replacement hinge pins has a greater length from said tool-receiving flange to the end opposite the threaded end and is used as the first of said two replacement hinge pins to facilitate subsequent assembly of hinge door brackets.
